(19) United States
(12) Patent Application Publication
(10) Pub. No.: US 2015/0339605 A1
(43) Pub. Date: Nov. 26, 2015

(54) METHODS OF GENERATING PROSPECTIVE LITIGATION EVENT SET

(71) Applicant: PRAEDICAT, INC., Culver City, CA (US)

(72) Inventors: Robert Thomas REVILLE, Culver City, CA (US); David LOUGHRAN, Culver City, CA (US)

(73) Assignee: PRAEDICAT, INC., Culver City, CA (US)

(21) Appl. No.: 14/282,998

(22) Filed: May 20, 2014

(51) Int. Cl. G06Q 10/06; G06Q 50/18

(52) U.S. Cl. CPC G06Q 10/0635; G06Q 50/18; G06Q 40/08

(57) ABSTRACT

Examples of the disclosure are directed to methods of generating an event set of prospective litigation scenarios and further generating a visualization of a subset of the event set that constitutes a worst-case mass litigation associated with a common agent. A prospective litigation scenario may describe a claim that a particular plaintiff or class of plaintiffs suffered a harm caused by an agent in an exposure setting, and a particular defendant or class of defendants are identified as potentially liable. Further, a prospective litigation scenario may be paired with a liability risk score indicating the likelihood that a particular defendant or class of defendant might be held financially responsible given the claim.

### FIELD OF THE DISCLOSURE

This relates generally to methods of generating an event set of prospective litigation scenarios and visualizing a prospective worst-case mass litigation consisting of a collection of scenarios related by a common agent.

### SUMMARY

Examples of the disclosure are directed to methods of generating an event set of prospective litigation scenarios and further generating a visualization of a subset of the event set that constitutes a worst-case mass litigation associated with a common agent. A prospective litigation scenario may describe a claim that a particular plaintiff or class of plaintiffs suffered a harm caused by an agent in an exposure setting, and a particular defendant or class of defendants are identified as potentially liable. Further, a prospective litigation scenario may be paired with a liability risk score indicating the likelihood that a particular defendant or class of defendant might be held financially responsible given the claim. Examples disclosed herein generate an event set of prospective litigation scenarios based, in part, on a corpus of scientific literature (including abstracts, articles, and/or article metadata, among other possibilities). Such an event set of scenarios can be used to determine the catastrophic liability risk, or prospective worst-case mass litigation, presented by an agent. A prospective worst-case mass litigation is a combination of litigation scenarios in an event set where all scenarios associated with a common agent are included. Further, a prospective worst-case mass litigation can be visualized by generating a map showing the stream of commerce relationships between and among the exposure settings associated with a particular agent.

### BRIEF DESCRIPTION OF THE DRAWINGS

FIG. 1 illustrates an exemplary method of generating an event set of prospective litigation scenarios according to examples of the disclosure.

FIG. 2 illustrates an exemplary visualization of a prospective worst-case mass litigation according to examples of the disclosure.

FIG. 3 illustrates an exemplary method of generating a visualization of a prospective worst-case mass litigation associated with a common agent according to examples of the disclosure.

FIG. 4 illustrates an exemplary system for generating an event set of prospective litigation scenarios and/or generating a visualization of a prospective worst-case mass litigation associated with a common agent according to examples of the disclosure.

### DETAILED DESCRIPTION

In the following description of embodiments, reference is made to the accompanying drawings which form a part hereof, and in which it is shown by way of illustration specific embodiments which can be practiced. It is to be understood that other embodiments can be used and structural changes can be made without departing from the scope of the disclosed embodiments.

Examples of the disclosure are directed to methods of generating an event set of prospective litigation scenarios and further generating a visualization of a subset of the event set that constitutes a worst-case mass litigation associated with a common agent. A prospective litigation scenario may describe a claim that a particular plaintiff or class of plaintiffs suffered a harm caused by an agent in an exposure setting, and a particular defendant or class of defendants are identified as potentially liable. Further, a prospective litigation scenario may be paired with a liability risk score indicating the likelihood that a particular defendant or class of defendant might be held financially responsible given the claim. Examples disclosed herein generate an event set of prospective litigation scenarios based, in part, on a corpus of scientific literature (including abstracts, articles, and/or article metadata, among other possibilities). Such an event set of scenarios can be used to determine the catastrophic liability risk, or prospective worst-case mass litigation, presented by an agent. A prospective worst-case mass litigation is a combination of litigation scenarios in an event set where all scenarios associated with a common agent are included. Further, a prospective worst-case mass litigation can be visualized by generating a map showing the stream of commerce relationships between and among the exposure settings associated with a particular agent.

Although examples of the disclosure are described in terms of worst-case mass litigation, examples are not so limited and may also be understood as instances of maximum clash. In insurance parlance, clash may refer to two or more insurance claims driven by the same cause (e.g., the same event, related events, etc.). Accordingly, the aggregate of prospective litigation scenarios for a particular agent may be understood as an instance of maximum clash due to the particular agent. Further, an aggregate liability risk associated with the particular agent may be a measure of probable maximum loss due to the particular agent.

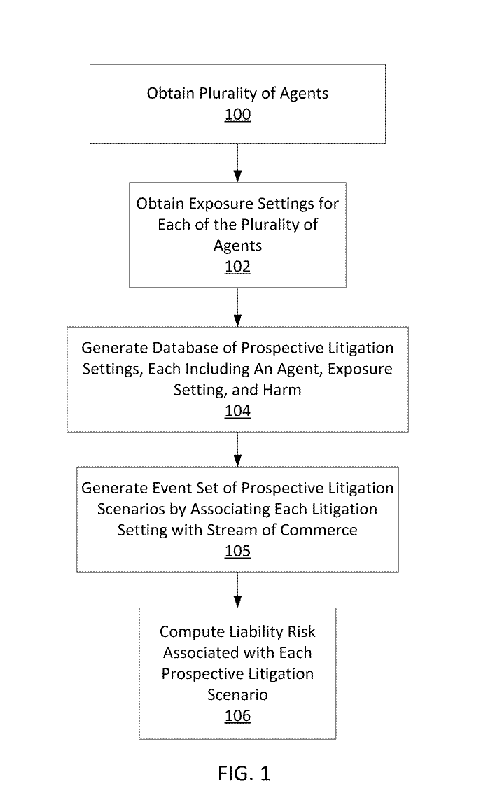

FIG. 1 illustrates an exemplary method of generating an event set of prospective litigation scenarios according to examples of the disclosure. A prospective litigation setting differs from a prospective litigation scenario in that the prospective defendants or class of defendants are not yet identified. As discussed above, a prospective litigation scenario may describe a claim that (1) a plaintiff suffered (2) a harm caused by (3) an agent in (4) an exposure setting, and (5) a defendant or class of defendants are identified as potentially at fault, and each prospective litigation scenario may contain some or all of these elements, among other possibilities.

A plurality of agents (e.g., a chemical, a material, a process, a business practice, a behavior, or any other hypothesized cause of a harm, etc.) may be obtained (100). In some examples, obtaining a plurality of agents may include obtaining a list of agents from a computer readable medium. In some examples, a list of agents may be automatically generated from a corpus of scientific literature, articles, abstracts, and/or article metadata.

One or more exposure settings may be obtained for each of the plurality of agents (e.g., a particular setting in which someone may be exposed to a particular agent, such as a product containing the agent, an industry that uses a product containing the agent, a place that includes a product containing the agent, etc.) (102). For example, a corpus of scientific literature may be coded with metadata indicating, for each article, one or more agents mentioned in the article and one or more exposure settings mentioned in the article. One or more exposure settings may be obtained for a particular agent by processing the metadata of the corpus to automatically extract any exposure settings that coincide with the particular agent. In some examples, each article may further be coded to indicate a level of exposure to the particular agent for the exposure setting. In some examples, one or more exposure settings may be obtained from a computer readable medium storing exposure settings associated with the agent.

A database of prospective litigation settings may be generated, each prospective litigation setting including one of the plurality of agents, an exposure setting associated with the agent and a harm (e.g., bodily injury, property damage, etc.) associated with the agent (104). In some examples, a prospective litigation setting may further include a level of exposure associated with the exposure setting and the agent.

An event set of litigation scenarios may be generated from the database of litigation settings by associating the stream of commerce for all exposure settings to the database of litigation settings (105). In some examples, the resulting event set represents prospective litigation scenarios fully specified with one or more parties in an associated stream of commerce. One or more parties in the stream of commerce may be included or excluded depending upon the specification of the claims. For example, for occupational exposures to a harmful product in the United States, an employer might be excluded from the litigation scenarios.

In some examples, a harm associated with the agent may be obtained from a list of agent-harm pairs or a list of harms associated with an agent, stored in a computer readable medium. In some examples, harms may be extracted from scientific literature, articles, abstracts, and/or article metadata. For example, harms associated with an agent may be obtained by processing article metadata to automatically extract any harms that coincide with the particular agent. In some examples, a prospective litigation scenario may include a particular agent, a particular exposure setting, and a particular harm, and the generation of the prospective litigation scenario may be based on a first article linking the particular agent with the particular harm and a second article linking the particular agent with the particular exposure setting, even if no single article links all three.

A liability risk score associated with each of the prospective litigation scenarios may be computed (e.g., a likelihood that a party will be held financially responsible as a result of a claim 106). In some examples, a liability risk score may be calculated based on a general causation score (e.g., a likelihood that the agent causes the harm, calculated based on scientific literature) and/or a specific causation score (e.g., a likelihood that a particular defendant in a particular setting was responsible for a harm). Example methods of calculating a general causation score can be found in U.S. patent application Ser. No. 14/135,436, filed electronically on Dec. 19, 2013, the disclosure of which is herein incorporated by reference in its entirety. In some examples, the liability risk score may be the general causation score. In some examples, the liability risk score may be the same as an associated link quality score (e.g., the link quality score may be associated with a particular agent-defendant pair included in the prospective litigation scenario).

In some examples, a class of prospective plaintiffs associated with an exposure setting (e.g., consumers of a particular product, employees in a particular industry, etc.) may be identified. The class of prospective plaintiffs may be associated with one or more prospective litigation scenarios that include the exposure setting.

In some examples, a plurality of liability risk scores may be aggregated across a subset of the prospective litigation scenarios (e.g., the subset of scenarios associated with one or more particular agents, one or more particular defendants, etc.) to obtain an aggregated liability risk score (indicating an aggregated liability risk for a particular agent, defendant, etc., depending on the subset). Further, in some examples, aggregating the plurality of liability risk scores may include weighting each liability risk score based on a link quality score associated with the corresponding prospective litigation scenario.

In some examples, the liability risk score may be calculated based upon an estimate of (1) the expected settlement dollar value of the litigation scenario assuming the scenario represents an actual litigation claim and (2) the expected number of plaintiffs in the litigation settings. In such a case, an aggregated liability risk score represents an estimate of the potential maximum dollar value of the selected set of litigation scenarios. Further, in an insurance context, the aggregated liability risk score may represent a probable maximum loss associated with maximum clash due to a particular agent.

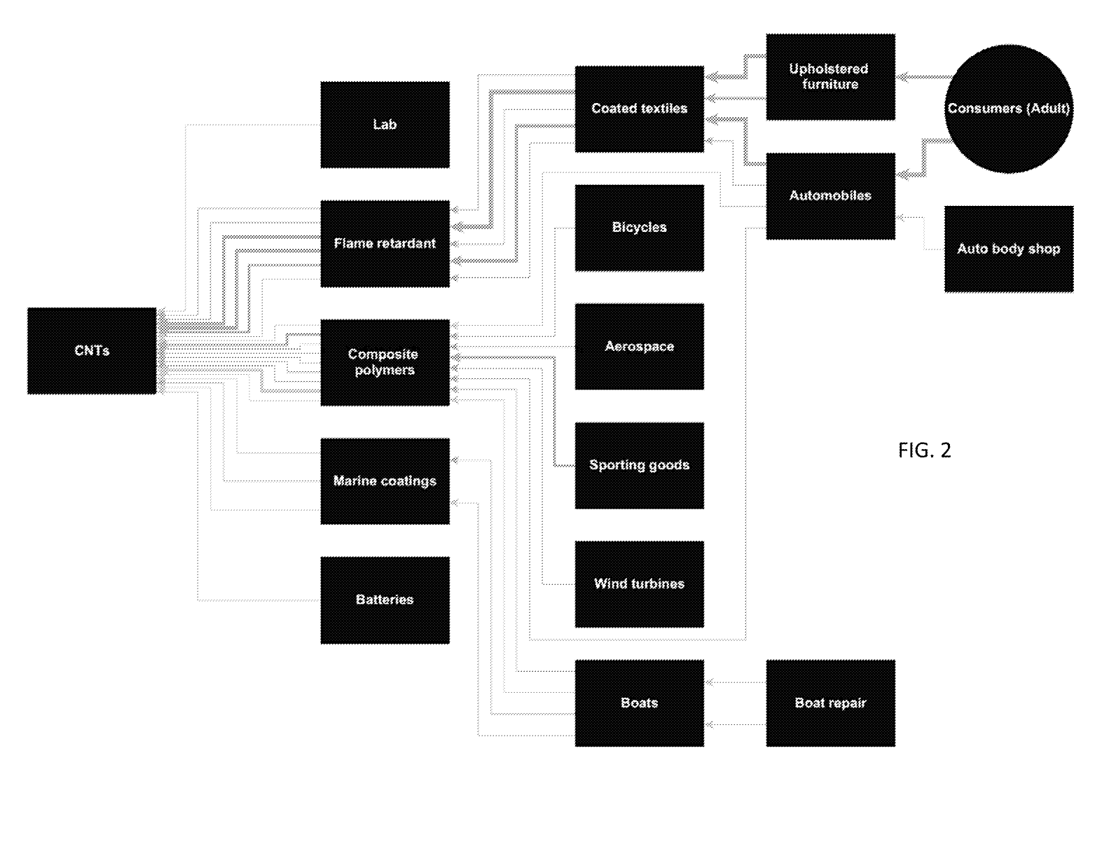

FIG. 2 illustrates an exemplary visualization of a worst-case mass litigation associated with a common agent according to examples of the disclosure. For example, FIG. 2 illustrates a visualization of a worst-case mass litigation for carbon nanotubes (CNTs). Each rectangle may represent a particular occupational setting in which an employee may be exposed to carbon nanotubes. In some examples, each circle may represent a particular consumer setting in which a consumer may be exposed to carbon nanotubes.

In some examples, the links in the visualization may represent a relationship in the stream of commerce that may give rise to a prospective litigation scenario. For example, FIG. 2 illustrates that carbon nanotubes are used in lab settings, flame retardant materials, composite polymers, marine coatings, and batteries. Further, flame retardant materials are used in coated textiles; composite polymers are used in automobiles, bicycles, the aerospace industry, sporting goods, wind turbines, and boats; and marine coatings are used in boats. Coated textiles are used in upholstered furniture and automobiles; boats are used in boat repairs; and automobiles are used in auto body shops. Finally, automobiles and upholstered furniture are purchased by consumers. Each of these relationships may be represented by link (e.g., an arrow) in the visualization.

A link can indicate that the parties associated with the exposure settings may be included in a prospective litigation scenario. For example, an arrow points from consumers to automobiles because consumers purchase automobiles. A consumer that is harmed by carbon nanotubes in a purchased automobile may sue the automobile manufacturer. Accordingly, a prospective litigation scenario may include carbon nanotubes as an agent, automobile consumers as a plaintiff, and automobile manufacturers as a defendant. Further, a plaintiff may sue anyone further upstream in the stream of commerce. Because coated textiles are used in automobiles, an automobile consumer may sue the manufacturer of the coated textiles. Accordingly, another prospective litigation scenario may include carbon nanotubes as an agent, automobile consumers as a plaintiff, and coated textile manufacturers as a defendant. In some examples, the plaintiff may be employees in an occupational setting. For example, an employee of an automobile manufacturer may be harmed by carbon nanotubes, and a prospective litigation scenario may include carbon nanotubes as an agent, automobile manufacturing employees as a plaintiff, and coated textile manufacturers as a defendant.

In some examples, visual characteristics of a link may be determined based on elements of an associated prospective litigation scenario. A color of a link may be determined based on a liability risk score of an associated prospective litigation scenario. For example, a link may be colored green for a relatively low liability risk score (e.g., less than 0.3), a link may be colored yellow for a relatively moderate liability risk score (e.g., between 0.3 and 0.6), and a link may be colored red for a relatively high liability risk score (e.g., higher than 0.6).

In some examples, a thickness of a link may be determined based on a number of plaintiffs in an associated prospective litigation scenario (e.g., a link associated with a relatively high number of plaintiffs may be thicker than a link associated with a relatively low number of plaintiffs). For example, FIG. 2 illustrates two links between upholstered furniture and coated textiles. The thicker link may be associated with a prospective litigation scenario including consumers of upholstered furniture as plaintiffs, and the thinner link may be associated with a prospective litigation scenario including employees of the upholstered furniture manufacturer as plaintiffs. The thicker link is thicker because there are more consumers of upholstered furniture than there are employees of the upholstered furniture manufacturer, and thus there are more prospective plaintiffs associated with the thicker link.

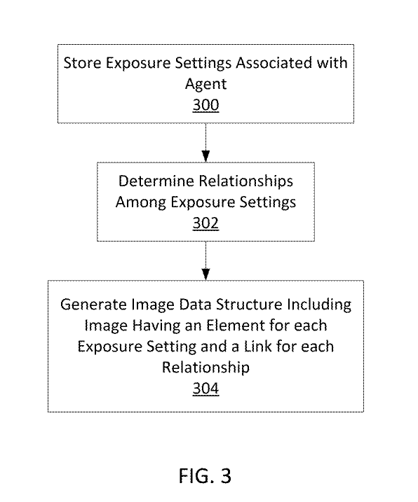

FIG. 3 illustrates an exemplary method of generating a visualization of litigation scenario relationships in a stream of commerce of an agent according to examples of the disclosure. A prospective worst-case mass litigation is a combination of litigation scenarios in an event set where all scenarios associated with a common agent are included. A plurality of exposure settings associated with the agent may be stored in a computer readable medium (300). The exposure settings may be obtained in any number of ways, including as described above with respect to FIG. 1.

A plurality of relationships among the exposure settings may be determined based on a stream of commerce from the agent to each of the exposure settings (e.g., a relationship between a product including the agent and a commercial setting may indicate that the product including the agent is used in the commercial or consumer setting; a relationship between a first product and a second product may indicate that the second product contains the first product; etc.) (302). In some examples, the relationships may be manually input by users. In some examples, the relationships may be automatically determined based on scientific article metadata and/or databases as described above with respect to determining exposure settings and prospective defendants.

An image data structure including an image may be generated (304). The image may have a plurality of elements and a plurality of links. Each element may correspond to one of the exposure settings (e.g., each element may be a rectangle with a label indicating the corresponding exposure setting), and each link may correspond to one of the relationships among the exposure settings (e.g., each link may be an arrow or a line connecting one element to another element indicating a relationship between the corresponding exposure settings).

In some examples, the plurality of elements may include a first element and a second element, and the plurality of links may include a first link from the first element to the second element, the first link corresponding to a first relationship between a first exposure setting and a second exposure setting.

In some examples, the first link may be an arrow pointing from the first element to the second element, and the first element may be downstream of the second element in the stream of commerce (e.g., the second element may be a first product containing the agent, and the first element may be a second product containing the first product, an industry that uses the first product, etc.).

In some examples, the first link may have a first color, and the first color may be determined based on a liability risk associated with the first relationship (e.g., a liability risk of a prospective litigation scenario including the first exposure setting or the second exposure setting, among other possibilities).

In some examples, the first link may have a first thickness, and the first thickness may be determined based on a size of a class of plaintiffs associated with the first relationship (e.g., a number of plaintiffs that would be exposed in the first exposure setting or the second exposure setting, among other possibilities).

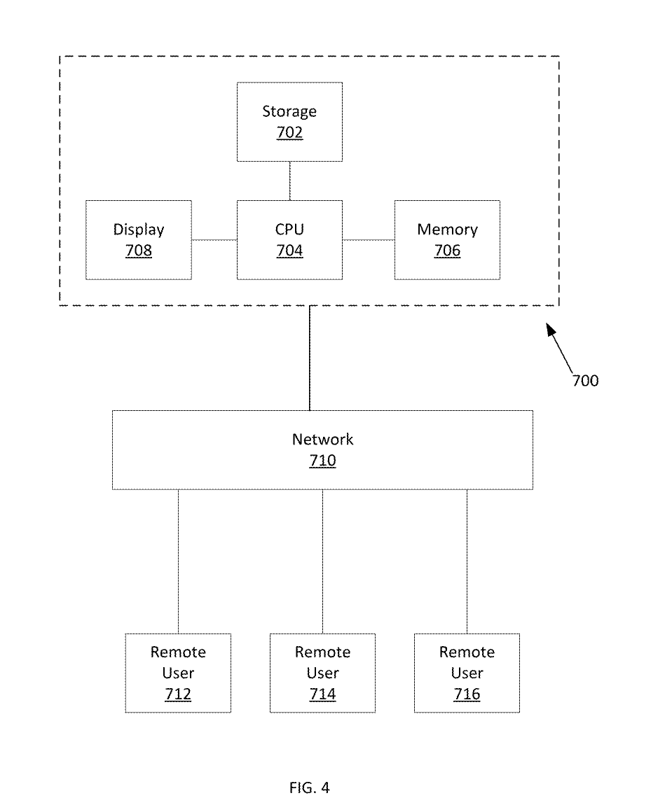

FIG. 4 illustrates an exemplary system 700 for generating an event set of prospective litigation scenarios and/or generating a visualization of a worst-case mass litigation associated with a common agent according to examples of the disclosure. The system 700 can include a CPU 704, storage 702, memory 706, and display 708. The CPU 704 can perform the methods illustrated in and described with reference to FIGS. 1-3. Additionally, the storage 702 can store data and instructions for performing the methods illustrated and described with reference to FIGS. 1-3. The storage can be any non-transitory computer readable storage medium, such as a solid-state drive or a hard disk drive, among other possibilities. Visualizations of the data, such as those illustrated in FIG. 2 may be displayed on the display 708.

The system 700 can communicate with one or more remote users 712, 714, and 716 over a wired or wireless network 710, such as a local area network, wide-area network, or internet, among other possibilities. The steps of the methods disclosed herein may be performed on a single system 700 or on several systems including the remote users 712, 714, and 716.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. A method of generating an event set of prospective litigation scenarios, the method comprising:
obtaining a plurality of agents;
obtaining one or more exposure settings for each of the plurality of agents;
generating a database of prospective litigation settings, each prospective litigation setting including one of the plurality of agents, an exposure setting associated with the agent and a harm associated with the agent;
generating an event set of prospective litigation scenarios by associating each litigation setting with a stream of commerce; and
computing a liability risk score associated with each of the prospective litigation scenarios.

2. The method of claim 1, the method further comprising:
identifying a class of prospective plaintiffs associated with an exposure setting; and
associating the class of prospective plaintiffs with one or more prospective litigation scenarios including the exposure setting.

3. The method of claim 1, wherein the event set of prospective litigation scenarios is generated based on metadata of a corpus of scientific literature.

4. The method of claim 1, the method further comprising:
obtaining a plurality of articles associated with a first agent; and
extracting, from the plurality of articles, a plurality of exposure settings associated with the first agent.

5. The method of claim 1, further comprising:
aggregating a plurality of liability risk scores across a subset of the prospective litigation scenarios to obtain an aggregated liability risk score.

6. The method of claim 5, wherein aggregating the plurality of liability risk scores includes weighting each liability risk score based on a link quality score associated with the corresponding prospective litigation scenario.

7. A method of generating a visualization of a worst-case mass litigation for an agent, the method comprising:
storing, in a computer readable medium, a plurality of exposure settings associated with the agent;
determining a plurality of relationships among the exposure settings based on a stream of commerce from the agent to each of the exposure settings; and
generating an image data structure including an image having:
a plurality of elements, each element corresponding to one of the exposure settings; and
a plurality of links, each link corresponding to one of the relationships among the exposure settings.

8. The method of claim 7, wherein the plurality of elements includes a first element and a second element, and the plurality of links includes a first link from the first element to the second element, the first link corresponding to a first relationship between a first exposure setting and a second exposure setting.

9. The method of claim 8, wherein the first link is an arrow pointing from the first element to the second element, and the first element is downstream of the second element in the stream of commerce.

10. The method of claim 8, wherein the first link has a first color, the method further comprising:
determining the first color based on a liability risk associated with the first relationship.

11. The method of claim 8, wherein the first link has a first thickness, the method further comprising:
determining the first thickness based on a size of a class of plaintiffs associated with the first relationship.

12. The method of claim 8, wherein each of the exposure settings is associated with one or more defendants in the stream of commerce, and the defendants associated with the plurality of exposure settings represent all defendants in the worst-case mass litigation for the agent.

13. A non-transitory computer readable storage medium storing instructions executable to perform a method of generating an event set of prospective litigation scenarios, the method comprising:
obtaining a plurality of agents;
obtaining one or more exposure settings for each of the plurality of agents;
generating a database of prospective litigation settings, each prospective litigation setting including one of the plurality of agents, an exposure setting associated with the agent and a harm associated with the agent;
generating an event set of prospective litigation scenarios by associating each litigation setting with a stream of commerce; and
computing a liability risk score associated with each of the prospective litigation scenarios.

14. An electronic device comprising:
one or more processors;
a memory; and
one or more programs stored in the memory and configured to be executed by the one or more processors, the one or more programs including instructions for performing a method of generating an event set of prospective litigation scenarios, the method comprising:
obtaining a plurality of agents;
obtaining one or more exposure settings for each of the plurality of agents;
generating a database of prospective litigation settings, each prospective litigation setting including one of the plurality of agents, an exposure setting associated with the agent and a harm associated with the agent;
generating an event set of prospective litigation scenarios by associating each litigation setting with a stream of commerce; and
computing a liability risk score associated with each of the prospective litigation scenarios.

15. A non-transitory computer readable storage medium storing instructions executable to perform a method of generating a visualization of a worst-case mass litigation for an agent, the method comprising:
storing a plurality of exposure settings associated with the agent;
determining a plurality of relationships among the exposure settings based on a stream of commerce from the agent to each of the exposure settings; and
generating an image data structure including an image having:
a plurality of elements, each element corresponding to one of the exposure settings; and
a plurality of links, each link corresponding to one of the relationships among the exposure settings.

16. An electronic device comprising:
one or more processors;
a memory; and
one or more programs stored in the memory and configured to be executed by the one or more processors, the one or more programs including instructions for performing a method of generating a visualization of a worst-case mass litigation for an agent, the method comprising:
storing a plurality of exposure settings associated with the agent;
determining a plurality of relationships among the exposure settings based on a stream of commerce from the agent to each of the exposure settings; and
generating an image data structure including an image having:
a plurality of elements, each element corresponding to one of the exposure settings; and
a plurality of links, each link corresponding to one of the relationships among the exposure settings.
